(19) United States
(12) Patent Application Publication
(10) Pub. No.: US 2013/0166273 A1
(43) Pub. Date: Jun. 27, 2013

(54) CIRCUIT EMULATION APPARATUS AND CIRCUIT EMULATION METHOD

(71) Applicant: FUJITSU LIMITED, Kawasaki-shi (JP)

(72) Inventor: Katsuya SUGA, Kawasaki (JP)

(21) Appl. No.: 13/669,572

(22) Filed: Nov. 6, 2012

(30) Foreign Application Priority Data
Dec. 26, 2011 (JP) 2011-284409

(51) Int. Cl. G06F 17/50

(52) U.S. Cl. 703/28

(57) ABSTRACT

A circuit emulation apparatus includes an emulator unit configured to emulate an operation of a circuit, a replacement unit configured to replace one or more redundant bits with a predetermined bit pattern when information bits and the one or more redundant bits of read data that is read from a first memory by the circuit are all zeros, and a supply unit configured to supply the information bits and the predetermined bit pattern as the read data to the circuit.

### CROSS-REFERENCE TO RELATED APPLICATIONS

The present application is based upon and claims the benefit of priority from the prior Japanese Patent Application No. 2011-284409 filed on Dec. 26, 2011, with the Japanese Patent Office, the entire contents of which are incorporated herein by reference.

### FIELD

The disclosures herein relate to a circuit emulation apparatus, a circuit emulation method, and a circuit emulation program.

### BACKGROUND

Logic simulation is performed to check whether a designed circuit properly operates for the purpose of developing LSI (Large Scale Integrated circuits). In the logic simulation, a target circuit to be checked is described by use of a hardware description language such as Verilog or the like, and such a circuit description is compiled to generate configuration data for use in an emulator. Upon the generated configuration data being downloaded to an emulator, the target circuit is mapped in the emulator to embody the target circuit on the emulator. The circuit on the emulator is then operated to check whether the circuit properly works.

In general, a CPU (central processing unit) or the like uses ECC bits (redundant bits) generated by ECC (error correction code) calculation to detect and correct data error when reading and writing data from and to memory. Specifically, data and ECC bits are written to memory at the time of a data write operation, and the data and the ECC bits are read from the memory at the time of a data read operation to perform error check and correction with respect to the data. In the case of a processor having a cache memory, a memory controller generates ECC bits on a cache-line-by-cache-line basis. Data of a cache line together with the ECC bits are then written to a memory such as a DIMM (Dual Inline Memory Module). At the time of a data read operation, the memory controller performs ECC calculation based on the data and ECC bits read from the memory, thereby performing error check and correction with respect to the data. Redundant bits used for the purpose of error check and correction do not have to be ECC bits. Redundant bits may be parity-check bits, CRC (Cyclic Redundancy Check) bits, or the like.

In the case of a logic simulation, bits in the memory (physical, tangible memory device) of an emulator to which a target circuit accesses are all zeros in an initial default state. Namely, in the initial default state, all the data bits are zeros, and the corresponding redundant bits (e.g., ECC bits) are also zeros. However, correct redundant bits for data of which all the bits are zeros may be “ff”, for example. In such a case, it is generally necessary to make initial settings to the redundant bits. That is, the redundant bits are initially set to the value “ff” in all the memory areas in which all the bits are zeros prior to the commencement of an operation of a target circuit that is to be checked by an emulator. Such an initial setting is made in order to avoid an error that is detected when reading data from the memory areas in which all the bits are zeros if the redundant bits remain to be zeros.

In memory areas other than the memory area in which a test program to be executed by a CPU to be checked is stored, most of the data are zeros in the initial default state. As the memory volume increases, the size of the memory areas in which data are zeros also increases. This results in a problem that it takes a lengthy time to write a correct initial value (e.g., “ff”) to the redundant bits as described above. In emulator operations, all the data contents of a memory are logged, and, then, the logged data contents are restored in the memory as such a need arises for the purpose of resuming an operation from a predetermined restoration point. In so doing, the logging and restoring of data in the emulator may be omitted with respect to the memory areas in which all the bits are zeros. When “ff” is written in the redundant bits as described above, however, the logging and restoring of data in the emulator cannot be omitted. This results in a problem that it takes a lengthy time to log and restore data.

[Patent Document 1] Japanese Laid-open Patent Publication No. 2009-64238

### SUMMARY

According to an aspect of the embodiment, a circuit emulation apparatus includes an emulator unit configured to emulate an operation of a circuit, a replacement unit configured to replace one or more redundant bits with a predetermined bit pattern when information bits and the one or more redundant bits of read data that is read from a first memory by the circuit are all zeros, and a supply unit configured to supply the information bits and the predetermined bit pattern as the read data to the circuit.

The object and advantages of the embodiment will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a drawing illustrating the relationship between a host machine and an emulator;

FIG. 2 is a drawing illustrating an example of the configuration of a target circuit on the emulator together with a memory;

FIGS. 3A and 3B are drawings for explaining the setting of ECC bits in the memory;

FIG. 4 is a drawing illustrating an example of the configuration for avoiding ECC error at the time of reading data that maintains an initial default value of zero;

FIG. 5 is a drawing illustrating an example of the configuration of an ECC modify circuit;

FIGS. 6A and 6B are drawings illustrating changes in memory data occurring with the progress of an emulation operation;

FIG. 7 is a flowchart illustrating a procedure performed by the host machine;

FIG. 8 is a flowchart illustrating a procedure performed by the emulator; and

FIG. 9 is a drawing illustrating an example of the configuration of the host machine.

### DESCRIPTION OF EMBODIMENTS

In the following, embodiments of the invention will be described with reference to the accompanying drawings.

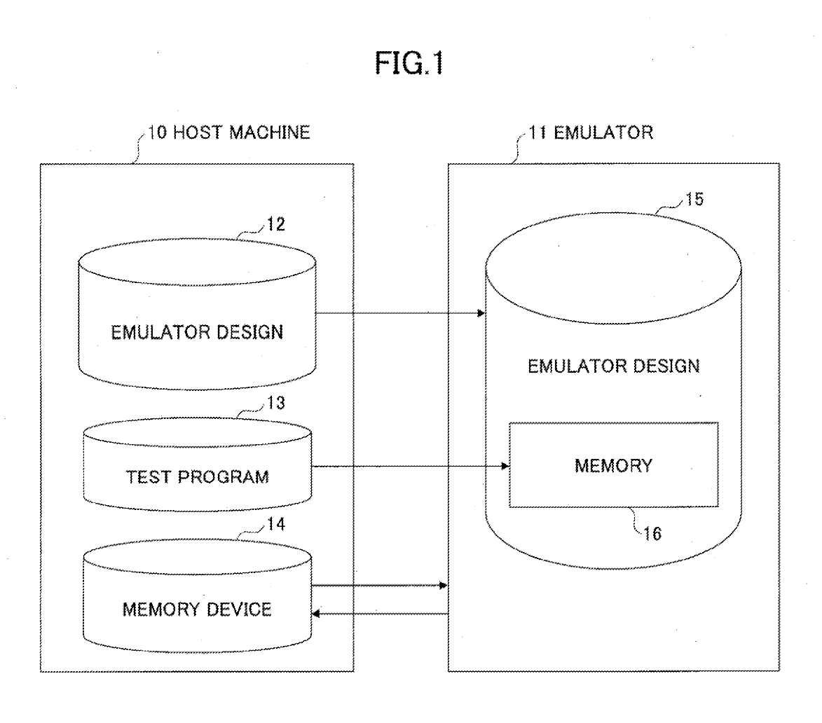

FIG. 1 is a drawing illustrating the relationship between a host machine and an emulator. As illustrated in FIG. 1, a host machine 10 is connected to an emulator 11. The host machine 10 has data that include an emulator design 12 and a test program 13. The host machine 10 also includes a memory device 14 for storing data such as data indicative of a state of the emulator 11. In the logic simulation, a target circuit to be checked is described by use of a hardware description language such as Verilog or the like, and such a circuit description is compiled by the host machine 10 to generate configuration data for use in an emulator. This generated configuration data is the emulator design (i.e., emulation program) 12. The host machine 10 downloads the emulator design 12 to the emulator 11, and maps the target circuit on the emulator 11. Namely, hardware resources of the emulator 11 are utilized to configure the target circuit on the emulator 11. In FIG. 1, the target circuit configured on the emulator 11 is illustrated as an emulator design 15.

When the target circuit of the emulator design 15 is a CPU, for example, the host machine 10 writes the test program 13 to the memory 16 of the emulator 11. The target circuit configured on the emulator 11 fetches and executes instructions of the test program 13 stored in the memory 16, thereby performing a predetermined operation. The operation of the target circuit is emulated by the emulator 11 in this manner, followed by a check made by the host machine 10 as to whether the circuit operation has properly come to an end. The check made by the host machine 10 reveals whether the logic design of the target circuit has a problem. It may be noted that the memory 16 is not an emulated circuit embodied by emulation, but is a physical, tangible memory device provided in the emulator 11. The memory 16 is used as a storage area for storing the test program 13, and is also used as a work area for the target circuit to use for its operation.

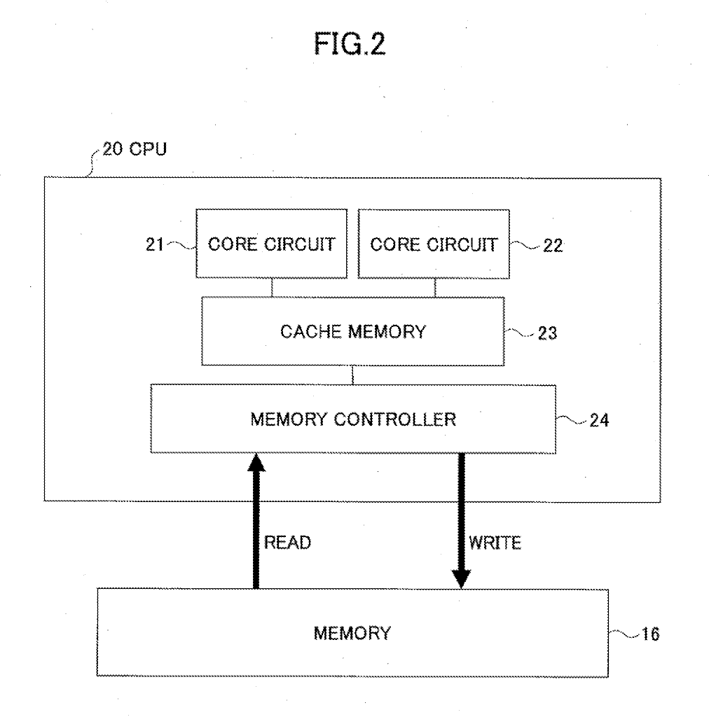

FIG. 2 is a drawing illustrating an example of the configuration of the target circuit on the emulator 11 together with the memory 16. In FIG. 2, the same or corresponding elements as those of FIG. 1 are referred to by the same or corresponding numerals, and a description thereof will be omitted as appropriate. A CPU 20 illustrated in FIG. 2 is the target circuit. The CPU 20 includes two core circuits 21 and 22, a cache memory 23, and a memory controller 24. The CPU 20 performs a data read operation and a data write operation with respect to the memory 16. In FIG. 2, the CPU 20 is a target circuit embodied by the emulator 11. The CPU 20 is not a circuit that is physically manufactured as fixed hardware, but is a logically configured circuit that is mapped to the hardware of the emulator 11. The emulator 11 may be an FPGA (field programmable gate array)-based emulator, or may be a processor-based emulator. The processor-based emulator may be a dynamic reconfigurable circuit in which a plurality of arithmetic units are connected through a network circuit. In such a dynamic reconfigurable circuit, connections between the arithmetic units through the network circuit and arithmetic instructions may be set in a reconfigurable manner based on configuration data. In FIG. 2, the memory 16 is a memory device of the emulator 11, and is implemented as a semiconductor integrated circuit manufactured as physical, tangible, fixed hardware.

The example of the configuration of the CPU 20 illustrated in FIG. 2 is only an example, and is not limited to this configuration. In this example of the configuration, the two core circuits 21 and 22 are provided, and share the cache memory 23. The core circuits 21 and 22 each serve as a processor unit which decodes fetched instructions, and executes various arithmetic logic operations in response to the decoded results. The cache memory 23 is a memory device that allows high-speed data read or write operations. A portion of the information stored in the memory 16 serving as a main memory is copied and stored in the cache memory 23, which allows a high-speed access to be made to this portion of the information. The cache contains a plurality of cache lines, and the copying of information from the main memory to the cache is performed on a cache-line-specific basis. The memory space of the main memory is divided in units of cache lines. The divided memory segments are sequentially assigned to the cache lines. Since the volume of the cache is smaller than the volume of the main memory, the memory segments of the main memory are repeatedly assigned to the same cache lines.

When a first access is performed by the core circuit 21 or 22 with respect to a given address in the memory space, data of the cache line inclusive of this address is copied to a corresponding cache line provided in the cache memory 23. When data to be accessed is already present in the cache memory 23 through such a copying operation, an access operation is performed with respect to the corresponding cache data (i.e., data comprised of a predetermined number of bits of one cache line). When data to be accessed is not present in the cache memory 23, a cache miss is detected. In the case of a cache miss, cache data to be replaced is written to the memory 16 according to need, followed by copying cache data (i.e., data of a predetermined number of bits of one cache line) from the memory 16 to the cache memory 23.

When writing data of one cache line to the memory 16, the memory controller 24 performs ECC calculation or the like to generate redundant bits for such data, and stores the redundant bits together with the data in the memory 16. When reading data of one cache line from the memory 16, the memory controller 24 also reads the corresponding redundant bits from the memory 16, and performs ECC calculation or the like with respect to the data bits (i.e., information bits) and the redundant bits to perform error detection and correction. In the following, a description will be given of an example in which redundant bits are ECC bits. However, the redundant bits for use in error detection and/or correction are not limited to ECC bits. The redundant bits may be parity-check bits, CRC (Cyclic Redundancy Check) bits, or the like.

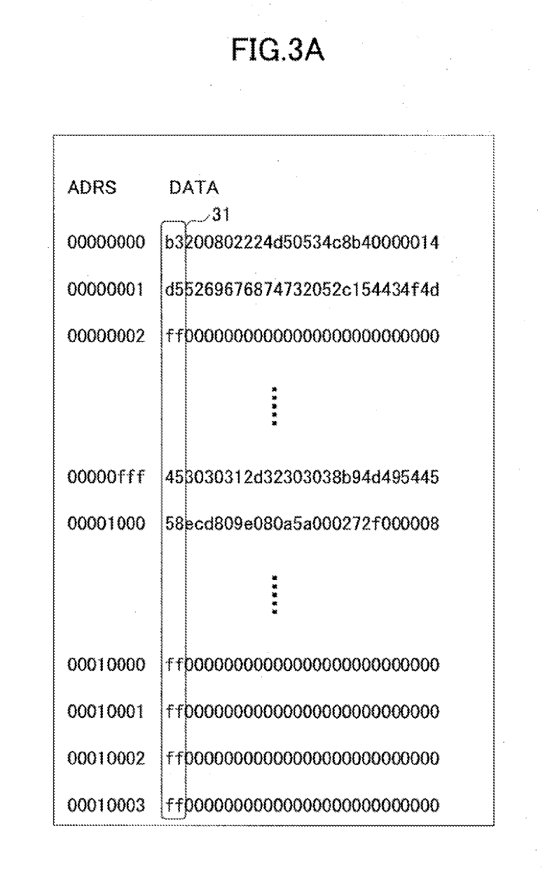

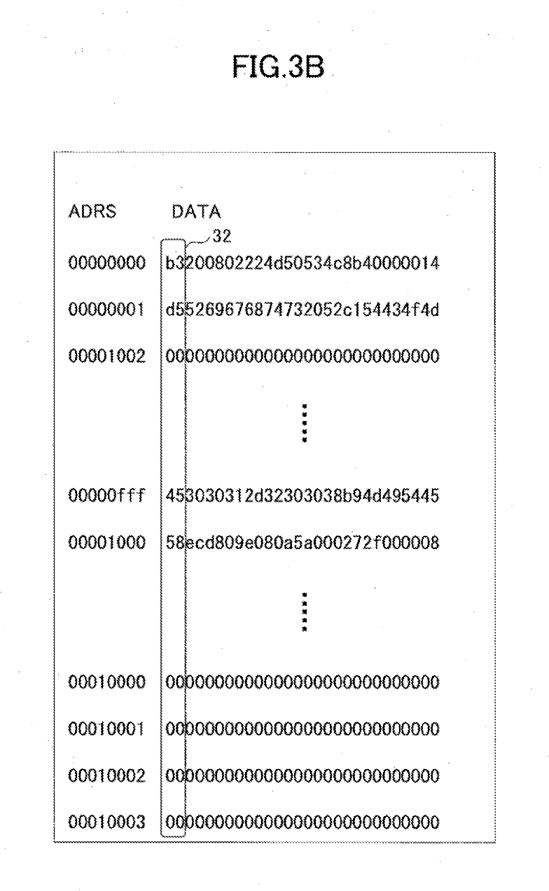

FIGS. 3A and 3B are drawings for explaining the setting of ECC bits in the memory 16. FIG. 3A is a drawing illustrating the setting of ECC bits in a related-art memory. FIG. 3B is a drawing illustrating the setting of ECC bits in the memory 16 of the present embodiment. In FIG. 3A and FIG. 3B, each row illustrates an address ADRS and data DATA assigned thereto. The width of the data DATA is 14 bytes, which correspond to the data width of one cache line. The address ADRS increases by one for each row, i.e., for each data portion having a predetermined bit width equal to one cache line, which is one of the cache lines that are successively arranged. The first one byte of the 14-byte data is ECC bits, and the 13 remaining bytes are data bits (i.e., information bits). In FIG. 3A and FIG. 3B, a numerical value of each digit is represented by a hexadecimal number (0 to f), and each digit corresponds to 4 bits. In the memory, all data (i.e., all bits) are zeros in an initial default state.

In the related-art setting of ECC bits illustrated in FIG. 3A, ECC bits 31 are set to proper bit values for all the data (i.e., all the data items each having a predetermined bit width equal to one cache line). Namely, the ECC bits 31 have ECC bit values that are obtained by applying ECC calculation to the 13-byte data bits. Data at the address “00000000” or the address “00000fff” have values that are stored and different from the initial default value “0”. The bit values of the ECC bits 31 of such data are calculated by ECC calculation performed by the memory controller 24 as previously described. These calculated ECC bits are written to the memory 16 together with the data bits of write data. Data at the address “00000002” or the address “00010000” have values that remain to be the initial default value “0”. With respect to such data, the ECC bits “ff” corresponding to all-zero data bits are stored in the memory 16 by an initial setting process.

In the setting of ECC bits according to the present embodiment illustrated in FIG. 3B, ECC bits 32 are set to proper bit values for all the non-zero data (i.e., all the non-zero data items each having a predetermined bit width equal to one cache line). Namely, data at the address “00000000” or the address “00000fff” have values that are stored and different from the initial default value “0”. The bit values of the ECC bits 32 of such data are calculated by ECC calculation performed by the memory controller 24. These calculated ECC bits are written to the memory 16 together with the data bits of write data. Data at the address “00000002” or the address “00010000” have values that remain to be the initial default value “0”. With respect to such data, the bit values of the ECC bits 32 also remain to be the initial default value “00”.

In the present embodiment, as illustrated in FIG. 3B, the bit values of the ECC bits 32 are left unchanged from the initial default value “00”. Namely, an initial setting process for the ECC bits is not performed, which is different from the related-art case illustrated in FIG. 3A. With this arrangement, it is possible to shorten the time length required for various initial setting operations at the time of commencement of emulation by the emulator 11.

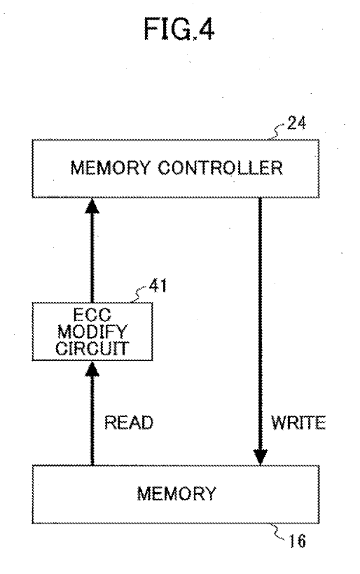

FIG. 4 is a drawing illustrating an example of the configuration for avoiding ECC error at the time of reading data that maintains an initial default value of zero. In FIG. 4, the same or corresponding elements as those of FIG. 1 are referred to by the same or corresponding numerals, and a description thereof will be omitted as appropriate. As illustrated in FIG. 4, an ECC modify circuit 41 is situated between the memory controller 24 and the memory 16 on the path for reading data from the memory device 14. The ECC modify circuit 41 is not included in the CPU 20 that is the target circuit. Nonetheless, the ECC modify circuit 41 may not be a circuit that is physically manufactured as fixed hardware, but may be a logically configured circuit that is mapped to the hardware of the emulator 11. Namely, the emulator design 12 in the system illustrated in FIG. 1 may be configured to include the design of the ECC modify circuit 41 as an additional circuit. This ECC modify circuit 41, together with the CPU 20, may be mapped to the emulator 11 as a logically configured circuit. Alternatively, the emulator 11 may have an embedded function corresponding to the ECC modify circuit 41 as physically fixed hardware.

The ECC modify circuit 41 replaces redundancy bits with a predetermined bit pattern when the data bits (i.e., information bits) and redundant bits of data read from the memory 16 by the memory controller 24 of the CPU 20 are all zeros. With this replacement process, the ECC modify circuit 41 supplies the data bits (i.e., information bits) and the predetermined bit pattern to the memory controller 24 of the CPU 20 as read data. The ECC modify circuit 41 supplies data bits and redundant bits to the memory controller 24 as read data when the data bits and redundant bits of data read from the memory 16 by the memory controller 24 have at least one bit thereof that is not zero. These processes by the ECC modify circuit 41 are performed when a read operation is performed as part of the emulation operation while the emulator 11 is emulating the operation of the CPU 20.

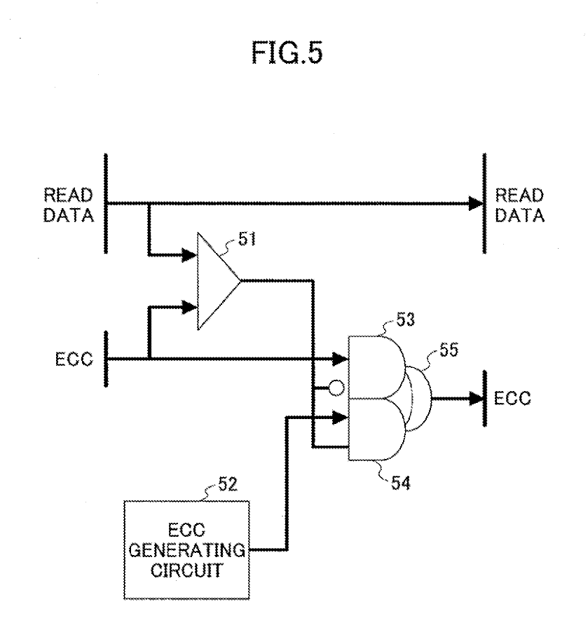

FIG. 5 is a drawing illustrating an example of the configuration of the ECC modify circuit 41. The ECC modify circuit 41 illustrated in FIG. 5 includes a zero detecting circuit 51, an ECC generating circuit 52, an AND circuit 53 having one positive-logic input and one negative-logic input, an AND circuit 54 having two positive-logic inputs, and an OR circuit 55. The zero detecting circuit 51 sets its output to 1 when the data bits (READ DATA illustrated in FIG. 5) and ECC bits (ECC illustrated in FIG. 5) of data read from the memory are both all zeros. The output of the zero detecting circuit 51 is set to zero when at least one bit of the data bits and the ECC bits is 1. The output of the zero detecting circuit 51 is applied to one input of the AND circuit 54 as a positive-logic value, and is applied to one input of the AND circuit 53 as a negative-logic value. The other input of the AND circuit 54 receives the output of the ECC generating circuit 52. The other input of the AND circuit 53 receives the ECC bits read from the memory 16. The output of the AND circuit 54 and the output of the AND circuit 53 are input into the OR circuit 55. The output of the OR circuit 55 is supplied to the memory controller 24 as ECC bits. The data (i.e., data bits) read from the memory 16 is supplied without any change to the memory controller 24 as read data. When the number of bits of the ECC bits is n, the AND circuit 53 includes n AND gates, and the output of the AND circuit 53 is comprised of n bits. By the same token, the AND circuit 54 also includes n AND gates, and the output of the AND circuit 54 is comprised of n bits. The OR circuit 55 includes n OR gates, and the output of the OR circuit 55 is comprised of n bits.

When all the bits of the data bits and the ECC bits are zero, the output of ECC generating circuit 52 is supplied to the memory controller 24 as ECC bits. When at least one bit of the data bits and the ECC bits is 1, the ECC bits read from the memory 16 are supplied to the memory controller 24 as ECC bits. Here, the output of the ECC generating circuit 52 has a bit pattern identical to the correct redundant bits that are used for data of which all the data bits (i.e., information bits) are zeros. Namely, the output of the ECC generating circuit 52 is “ff” in the case of the example illustrated in FIG. 3B.

In this manner, the retrieved redundant bits are replaced with correct redundant bits for which no error will be detected when all the bits of the data bits and the ECC bits are zeros, i.e., when data having the initial default value is read from the memory 16. The retrieved data bits and the replacing correct redundant bits are supplied to the memory controller 24 as read data. Accordingly, the memory controller 24 detects no ECC error upon reading data even when the bit values of the ECC bits 32 are left unchanged from the initial default value “00” as illustrated in FIG. 3B.

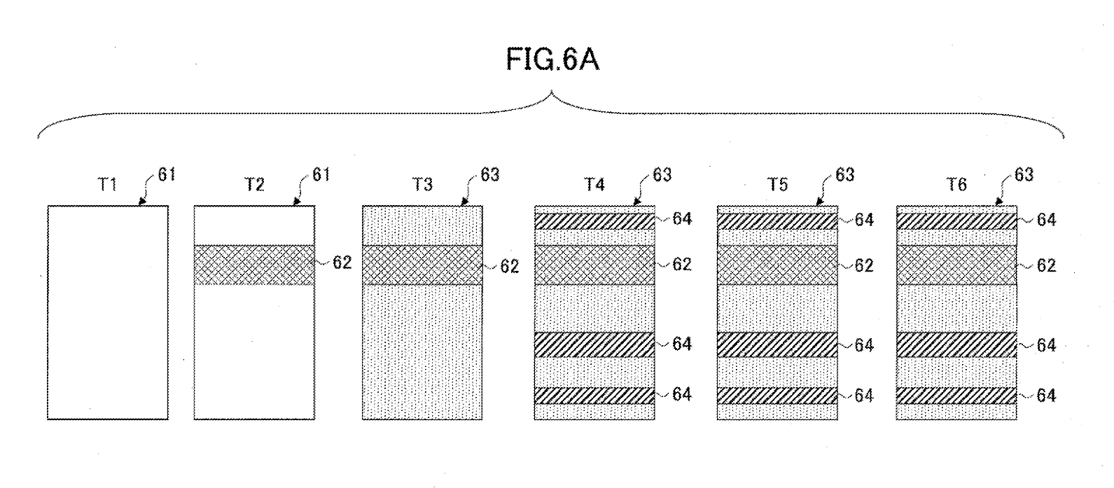

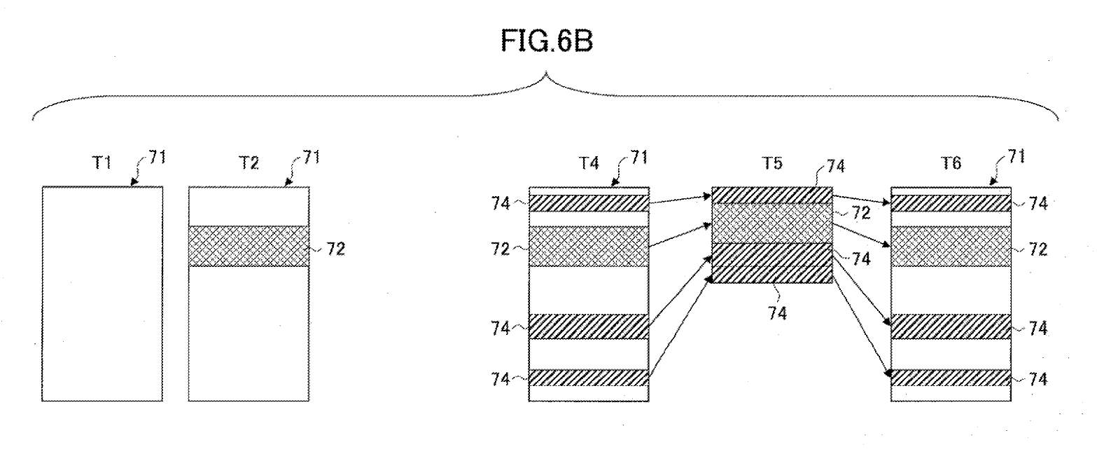

FIGS. 6A and 6B are drawings illustrating changes in the memory data occurring with the progress of an emulation operation. FIG. 6A is a drawing illustrating changes in the memory data occurring with the progress of a related-art emulation operation. FIG. 6B is a drawing illustrating changes in the memory data occurring with the progress of an emulation operation of the present embodiment. Time T1 indicates the state of the memory space at the commencement of emulation. In the related-art emulation operation illustrated in FIG. 6A, all the memory area of the memory at the time T1 is an initial-default-value area 61 in which all the bits are zeros.

At time T2, a test program 62 is written. The memory areas where the test program 62 is not written remain to be the initial-default-value area 61. At time T3, an initial setting operation is performed to write ECC bits in the initial-default-value area 61, so that the memory areas other than the area of the test program 62 become an initial-setting-completed area 63 in which the ECC bits “ff” are stored. At time T4, the CPU 20 (see FIG. 2) executes the test program. As a result of the execution of this test program, various execution resultant data 64 are written in the memory area.

At time T5, an operation to log all the data contents of the memory is performed. The state of another memory which has the logged memory data contents stored therein is illustrated at time T5 of FIG. 6A. As previously described, all the data contents of a memory in emulator operations are logged, and, then, the logged data contents are restored in the memory as such a need arises for the purpose of resuming an operation from a predetermined restoration point. In the system illustrated in FIG. 1, for example, all the data contents of the memory 16 are copied to the memory device 14, thereby logging the data contents of the memory 16. What is illustrated at the time T5 in FIG. 6A is the data stored in the memory area of the memory device 14 that has the data contents of the memory 16. All the data (i.e., the test program 62, the initial-setting-completed area 63, and the execution resultant data 64) of the memory 16 are stored in the memory device 14. This is because all the addresses in the memory 16 have some non-zero values written therein, which results in the data of all the addresses being copied to the memory device as log targets. Such a logging operation may be performed at predetermined time intervals (i.e., clock intervals), for example.

At time T6, an operation to restore the logged data contents to the memory is performed. The memory state of the memory 16 to which the data is restored is illustrated at time T6 of FIG. 6A. After the operation to log the data contents is performed at the time T5, the test program 62 continues to be executed, thereby changing the data contents of the memory 16. An error may occur thereafter. Upon such an error occurrence, the data restoring operation as described above is performed to resume the execution of the program from the time at which the logging of data was performed the last time. Because of this restoration operation, the memory state of the memory 16 illustrated at the time T6 is restored to the memory state observed at the time T4. In this restoration operation, all the data (i.e., the test program 62, the initial-setting-completed area 63, and the execution resultant data 64) are transferred from the memory device 14 to the memory 16.

In the emulation operation of the present embodiment illustrated in FIG. 6B, all the memory area of the memory at the time T1 is an initial-default-value area 71 in which all the bits are zeros. At time T2, a test program 72 is written. The memory areas where the test program 72 is not written remain to be the initial-default-value area 71. In the emulation operation of the present embodiment, the initial setting operation at the time T3 is not performed. At time T4, the CPU 20 (see FIG. 2) executes the test program. As a result of the execution of this test program, various execution resultant data 74 are written in the memory area.

At time T5, an operation to log some data contents of the memory is performed. The state of another memory which has the logged memory data contents stored therein is illustrated at time T5 of FIG. 6B. In the system illustrated in FIG. 1, some data contents of the memory 16 are copied to the memory device 14, thereby logging the data contents of the memory 16. What is illustrated at the time T5 in FIG. 6B is the data stored in the memory area of the memory device 14 that has the data contents of the memory 16. Among the initial-default-value area 71, the test program 72, and the execution resultant data 74, only the test program 72 and the execution resultant data 74 are copied from the memory 16 to the memory device 14. Namely, since all the bits of the data of the initial-default-value area 71 are zeros, the addresses at which all the bits of stored data are zeros are skipped, and data at the remaining addresses are copied from the memory 16 to the memory device 14. Such a selective copying operation is performed by a data logging function provided in the emulator 11.

At time T6, an operation to restore the logged data contents to the memory is performed. The memory state of the memory 16 to which the data is restored is illustrated at time T6 of FIG. 6B. When this restoration operation is to be performed after the occurrence of an error, the contents of the memory 16 are returned to the initial default state in conjunction with the resumption of the emulation operation. Accordingly, when only the test program 72 and the execution resultant data 74 are transferred from the memory device 14 to the memory 16 in the restoration operation, the memory state of the memory 16 illustrated at the time T6 is restored to the memory state observed at the time T4. In the emulation operation of the present embodiment as described above, the addresses at which data of the initial default state is stored are not subjected to logging and restoring in the data logging operation and in the data restoring operation. That is, the data are neither copied nor transferred.

In this manner, the contents of the memory are logged in the memory device 14, and, then, the contents of the memory 16 are restored from the memory device 14 to the memory 16. In such logging and restoring operations, all the data stored in the memory 16, except for the data whose bits are all zeros, are logged in the memory device 14. With this arrangement, an efficient emulation operation is achieved by reducing the amount of data that is copied and transferred in a data logging operation and in a data restoring operation, respectively.

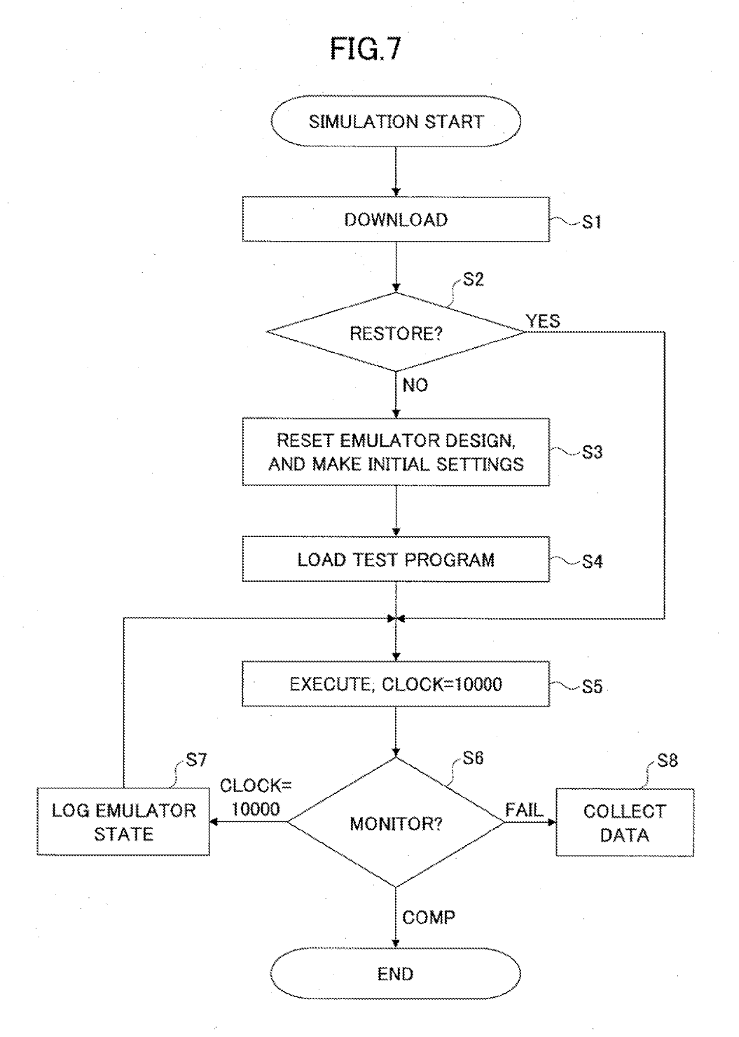

FIG. 7 is a flowchart illustrating a procedure performed by the host machine. Upon the start of emulation, the host machine 10 downloads the emulator design 12 to the emulator 11 in step S1. With this arrangement, the target circuit is mapped onto the emulator 11. Namely, hardware resources of the emulator 11 are utilized to configure the target circuit on the emulator 11. In the case of a reconfigurable-circuit-based emulator, the emulator 11 includes a reconfigurable arithmetic unit array, a sequencer, and a configuration memory. The reconfigurable arithmetic unit array includes a plurality of arithmetic units and a network circuit to provide reconfigurable connections between the arithmetic units. Arithmetic instructions contained in configuration data (i.e., the emulator design 12) specify operations performed by the arithmetic units. Connection data contained in the configuration data specify connections between the arithmetic units. Such configuration data is downloaded to the emulator 11, and is stored in the configuration memory of the emulator 11. From a plurality of configuration data pieces stored in the configuration memory, the sequencer selects a configuration data piece indicative of a current operation type of the reconfigurable arithmetic unit array. The configuration data piece selected by the sequencer is supplied to the reconfigurable arithmetic unit array, so that the reconfigurable arithmetic unit array operates according to the operation type corresponding to the configuration data. A reconfigurable circuit is implemented in this manner. In the case of an FPGA-based emulator, a plurality of logic gates and a network circuit for connecting between the logic gates in a reconfigurable manner, rather than the plurality of arithmetic units and the network circuit, are provided to implement a reconfigurable circuit.

In step S2, the host machine 10 checks whether the data contents of the memory 16 are to be restored. In the case of restoration (i.e., YES in step S2), the host machine 10 restores the data stored in the memory device 14 to the memory 16 of the emulator 11, and, then, the procedure proceeds to step S5. In the case of no restoration (i.e., NO in step S2), the host machine 10 instructs the emulator 11 in step S3 to reset an emulator design and to perform an initial setting operation. With this, a setting is made to the start address of a program counter that is provided in the CPU 20 to execute the test program 13, for example. In step S4, further, the host machine 10 writes the test program 13 in the memory 16 of the emulator 11.

In step S5, the host machine 10 sets the clock count to 10000 in the emulator 11, and then causes the emulator 11 to perform the operation of the CPU 20. In step S6, the host machine 10 monitors whether an error occurs during the operation of the CPU 20 performed by the emulator 11, whether the operation has come to an end, and whether the operation has been performed for 10000 clock cycles. When the monitoring in step S6 detects that the operation has been performed for 10000 clock cycles, the host machine 10 instructs the emulator 11 to log the state of the emulator 11. As a result, various data indicative of the state of the emulator 11 (i.e., the state of the circuits of the CPU 20) together with the memory contents of the memory 16 of the emulator 11 are stored in the memory device of the host machine 10. The procedure then goes back to step S5 to repeat the subsequent steps. When the monitoring in step S6 detects the occurrence of an error, the host machine 10 collects various data indicative of the state of the emulator 11 in step S8. When the monitoring in step S6 detects the termination of the operation of the CPU 20, the procedure comes to an end.

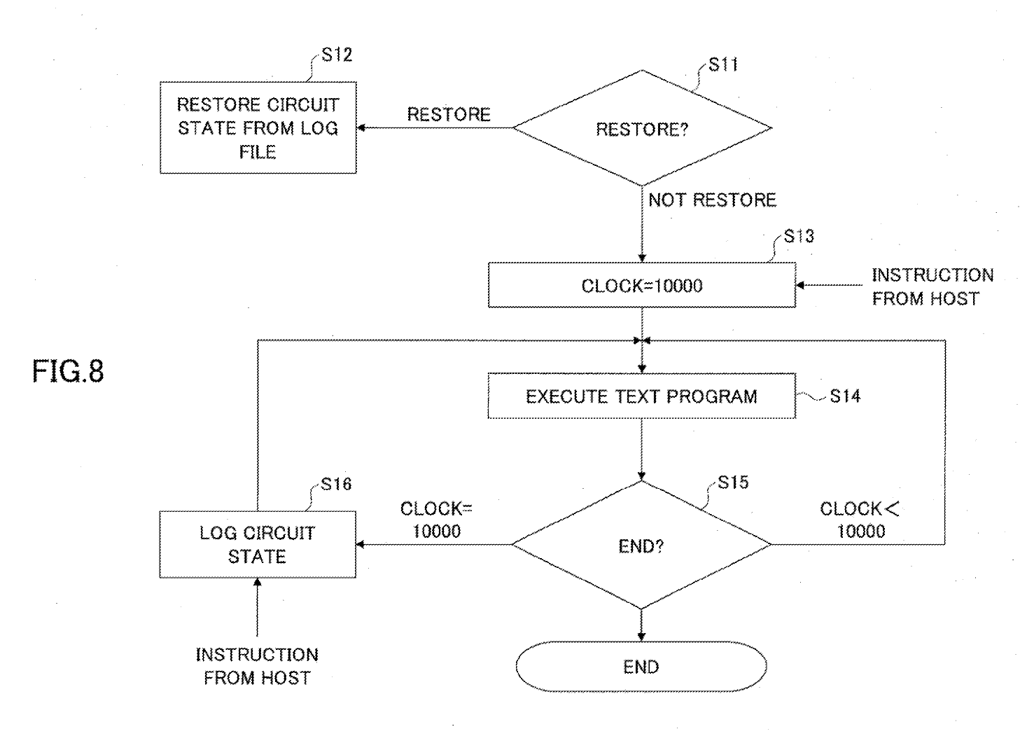

FIG. 8 is a flowchart illustrating a procedure performed by the emulator.

In step S11, a check is made as to whether data contents are to be restored. The following process differs depending on the result of this check. In the case of restoring data contents, the emulator 11 responds to an instruction from the host machine 10 to restore the data contents of the memory 16 from the memory device 14 of the host machine 10 to the memory 16 of the emulator 11 in step S12. Further, the states of the circuits of the CPU 20 on the emulator 11 are restored based on the log file. In the case of not restoring data contents, the emulator 11 sets the clock count to 10000 in step S13, followed by starting to perform the operation of the CPU 20. In step S14, the emulator suspends or terminates its operation upon detecting that an error occurs upon performing the operation of the CPU 20, detecting that the operation has come to an end, or detecting that the operation has been performed for 10000 clock cycles. When it is detected in step S15 that the operation has been performed for 10000 clock cycles, the emulator 11 logs circuit states in step S16 based on an instruction from the host machine 10. For example, various data indicative of the state of the emulator (i.e., the state of the circuits of the CPU 20) together with the memory contents of the memory 16 of the emulator 11 are sent to the host machine 10, which then stores the received data in the memory device 14. When the check in step S15 detects the termination of the operation of the CPU 20, the procedure comes to an end.

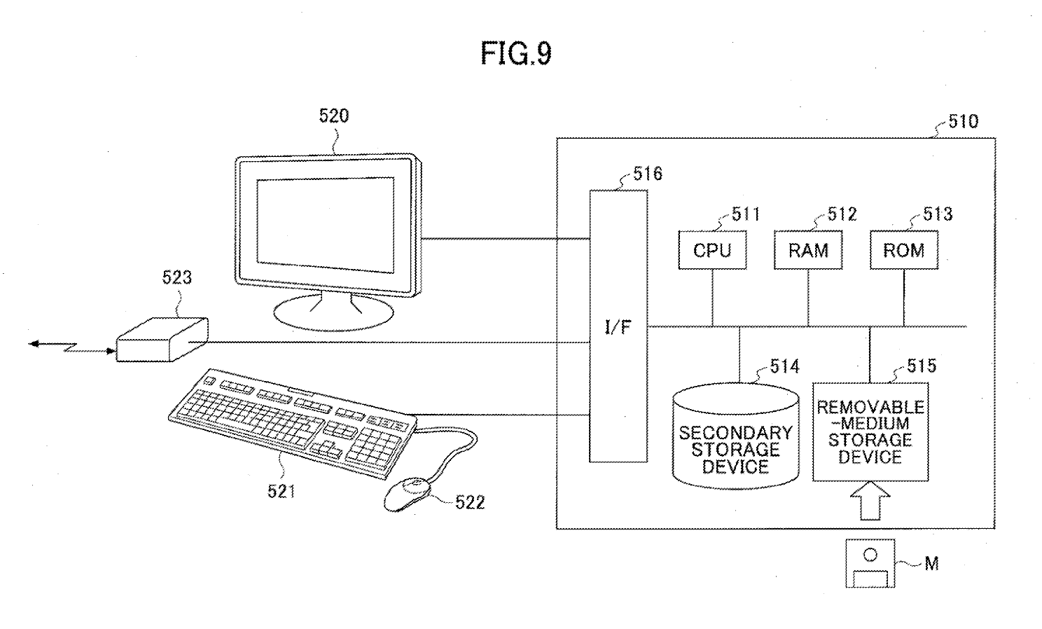

FIG. 9 is a drawing illustrating an example of the configuration of the host machine. As illustrated in FIG. 9, the host machine is implemented as a computer such as a personal computer, an engineering workstation, or the like The apparatus of FIG. 9 includes a computer 510, a display apparatus 520 connected to the computer 510, a communication apparatus 523, and an input apparatus. The input apparatus includes a keyboard 521 and a mouse 522. The computer 510 includes a CPU 511, a ROM 513, a secondary storage device 514 such as a hard disk, a removable-medium storage device 515, and an interface 516.

The keyboard 521 and mouse 522 provide user interface, and receive various commands for operating the computer 510 and user responses responding to data requests or the like. The display apparatus 520 displays the results of processing by the computer 510, and further displays various data that makes it possible for the user to communicate with the computer 510. The communication apparatus 523 provides for communication to be conduced with a remote site, and may include a modem, a network interface, or the like.

A program for performing the operations of the host machine 10 as previously described in the embodiments is provided as a computer program executable by the computer 510. This computer program is stored in a memory medium M that is mountable to the removable-medium storage device 515. The computer program is loaded to the RAM 512 or to the secondary storage device 514 from the memory medium M through the removable-medium storage device 515. Alternatively, the computer program may be stored in a remote memory medium (not shown), and is loaded to the RAM 512 or to the secondary storage device 514 from the remote memory medium through the communication apparatus 523 and the interface 516.

Upon user instruction for program execution entered through the keyboard 521 and/or the mouse 522, the CPU 511 loads the program to the RAM 512 from the memory medium M, the remote memory medium, or the secondary storage device 514. The CPU 511 executes the program loaded to the RAM 512 by use of an available memory space of the RAM 512 as a work area, and continues processing while communicating with the user as such a need arises. The ROM 513 stores therein control programs for the purpose of controlling basic operations of the computer 510.

By executing the computer program as described above, the computer 510 serves as the host machine 10 to perform the operations as described in the embodiments.

According to one embodiment of the present disclosures, it is possible to efficiently treat data of which all the bits are zeros in a memory that is provided with redundant bits.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A circuit emulation apparatus comprising:
an emulator unit configured to emulate an operation of a circuit;
a replacement unit configured to replace one or more redundant bits with a predetermined bit pattern when information bits and the one or more redundant bits of read data that is read from a first memory by the circuit are all zeros; and
a supply unit configured to supply the information bits and the predetermined bit pattern as the read data to the circuit.

2. The circuit emulation apparatus as claimed in claim 1, wherein the predetermined bit pattern is a bit pattern of redundant bits that are used for data whose data bits are all zeros.

3. The circuit emulation apparatus as claimed in claim 1, wherein when the information bits and the one or more redundant bits of the read data that is read from the first memory by the circuit include at least one bit that is not zero, the supply unit supplies the information bits and the one or more redundant bits to the circuit as the read data.

4. The circuit emulation apparatus as claimed in claim 1, further comprising a restoration unit configured to log contents of the first memory in a second memory and to restore the contents of the first memory from the second memory to the first memory, wherein the restoration unit logs all data stored in the first memory, except for data whose bits are all zeros, in the second memory.

5. A circuit emulation method performed by a circuit emulator, the circuit emulation method comprising:
emulating an operation of a circuit;
replacing one or more redundant bits with a predetermined bit pattern when information bits and the one or more redundant bits of read data that is read from a first memory by the circuit are all zeros; and
supplying the information bits and the predetermined bit pattern as the read data to the circuit.

6. The circuit emulation method as claimed in claim 5, wherein the predetermined bit pattern is a bit pattern of redundant bits that are used for data whose data bits are all zeros.

7. The circuit emulation method as claimed in claim 5, wherein when the information bits and the one or more redundant bits of the read data that is read from the first memory by the circuit include at least one bit that is not zero, the information bits and the one or more redundant bits are supplied to the circuit as the read data.

8. The circuit emulation method as claimed in claim 5, further comprising:
logging contents of the first memory in a second memory; and
restoring the contents of the first memory from the second memory to the first memory,
wherein all data stored in the first memory, except for data whose bits are all zeros, are logged in the second memory.

9. A non-transitory computer-readable medium having a circuit emulation program embodied therein for causing a circuit emulator to perform a process, the process comprising:
emulating an operation of a circuit;
replacing one or more redundant bits with a predetermined bit pattern when information bits and the one or more redundant bits of read data that is read from a first memory by the circuit are all zeros; and
supplying the information bits and the predetermined bit pattern as the read data to the circuit.

10. The non-transitory computer-readable medium as claimed in claim 9, wherein the predetermined bit pattern is a bit pattern of redundant bits that are used for data whose data bits are all zeros.

11. The non-transitory computer-readable medium as claimed in claim 9, wherein when the information bits and the one or more redundant bits of the read data that is read from the first memory by the circuit include at least one bit that is not zero, the information bits and the one or more redundant bits are supplied to the circuit as the read data.

12. The non-transitory computer-readable medium as claimed in claim 9, wherein the program causes the circuit emulator to further perform:
logging contents of the first memory in a second memory; and
restoring the contents of the first memory from the second memory to the first memory,
wherein all data stored in the first memory, except for data whose bits are all zeros, are logged in the second memory.
